(19) United States
(12) Patent Application Publication
(10) Pub. No.: US 2008/0217279 A1
(43) Pub. Date: Sep. 11, 2008

(54) Working Boom, Especially for Large Manipulators and Mobile Concrete Pumps

(75) Inventors: Stephan Gelies, Magdeburg (DE); Juergen Braun, Offenbach (DE)

Correspondence Address: DARBY & DARBY P.C., P.O. BOX 770, Church Street Station, New York, NY, 10008-0770, US

(73) Assignee: Putzmeister Concrete Pumps GmbH, Aichtal (DE)

(21) Appl. No.: 12/090,749

(22) PCT Filed: Oct. 17, 2006
(86) PCT No.: PCT/EP2006/009983

§ 371 Date: Apr. 18, 2008

(30) Foreign Application Priority Data
Oct. 18, 2005 (DE) 10 2005 050 134.6

(51) Int. Cl. B66C 13/16

(52) U.S. Cl. 212/278

(57) ABSTRACT

A working boom with a rotating head on a frame, which rotates about a vertical axis, and boom arms that are each either pivotable or slideable by the use of a drive unit. The working boom includes a control device that controls boom movement with the aid of actuators assigned to each drive unit. Path or angular sensors are assigned to the boom arms, bending axes, vertical axis and/or or drive units. At least one of the drive units includes a hydraulic cylinder with a ground end and a rod-side end. A force or pressure sensor is disposed on the ground end or rod-side end of the hydraulic cylinder. A data storage device receives a pre-set data field of pressure and/or force limit values in connection with a respective path or measurement value assigned to the boom arms, the pre-set data field being analytical or in tabular form. The control device has a safety routine in which a comparator receives output data of the force or pressure sensor and either output data from the path or angular sensors or quantities derived from the output data of the path or angular sensors, and performs a comparison with the data field to trigger a signal if the data from the sensors is outside the limit value data.

### CROSS REFERENCE TO PRIOR RELATED APPLICATIONS

This is a U.S. National Phase application under 35 U.S.C. §371 of International Application No. PCT/EP2006/009983, filed on Oct. 17, 2006, and claims the benefit of German Patent Application No. 10 2005 050 134.6, filed on Oct. 18, 2005. The International Application was published in German on Apr. 26, 2007 as WO 2007/045426 A1 under PCT Article 221(2)

### FIELD OF THE INVENTION

The invention relates to a working boom including a rotating head and at least one boom arm attached thereto.

### BACKGROUND

Working booms typically include a rotating head adapted to be rotated about a vertical axis on a chassis frame, a first boom arm that is adapted to be limitedly pivoted relative to the rotating head by means of a drive unit about a horizontal bending axis, and at least one additional boom arm adapted to be longitudinally moved along a thrust axis relative to an adjoining boom arm by means of an associated drive unit and/or pivoted about a horizontal bending axis. A control device, for example a remotely controllable control device, is provided for boom movement, which has actuators assigned to the individual drive units. In addition, at least one sensor for path or angle measurement is provided, which is assigned to at least one of the boom arms, the thrust or bending axes, the vertical axis and/or the drive units. In addition, pressure or force sensors are disposed on the ground-side and/or rod-side end of at least one of the drive units, which are embodied as hydraulic cylinders. The output data of the at least one sensor for path or angle measurement and of the pressure and force sensors are evaluated in an evaluation unit of a safety routine as a boom moves.

Working booms of this type are typically used in large manipulators, in automatic concrete pumps with a bending and a telescopic boom and in mobile telescopic hoisting devices.

Truck-mounted concrete pumps are often run by an operator who is responsible both for the pump controls and for the positioning of the end hose placed at the tip of the bending boom, by way of a remote control device. For this, the operator has to actuate multiple rotational degrees of freedom of the bending boom via the associated drive units while moving the bending boom in a non-structured three-dimensional working space while heeding the worksite limit conditions. To facilitate manipulations in this regard, DE-A 43 06 127 describes an operating device in which the redundant bending axes of the bending boom are jointly controlled in every rotational position of the boom, independent of their rotational axis, with a single control action of the remote controller. The basic prerequisite for such an activation of the bending boom is a position control, which includes, among other things, a sensor technology for path or angular measurement, which is assigned to the individual boom arms, bending axes and/or drive units. Malfunctions in technical systems of this type, which include both electronic and hydraulic components, cannot be fully precluded, therefore there is a need for safety monitoring that warns the operator and intervenes to safeguard in the functional sequence. For that, it is advantageous to have sensors that recognize the malfunctions as they appear and assess them with the goal of avoiding undesired consequences of malfunctions and damages. Such a safety devices is described in DE-A 101 07 107 in connection with position controls within the bending boom, for example to address the switched-on state of the hoisting valve, the presence or absence of movement presets via the remote controls, the appearance of excess control errors related to path or angle, or increased rates of such control errors, as well as to excess angular velocities.

Thus, there is a need to expand the safety monitoring to a monitoring of the load limits with regard to strength and stability. This problem appears, for example, in bending booms, the arms of which are in the folded-together state in the manner of an overhead roll-and-fold boom. Overhead roll-and-fold booms do in fact have an advantage in that the set of booms unfolds relatively simply and speedily. In contrast to other folding types, the set of booms, which in the deployed state has its first arm resting on the chassis frame, can be lifted about bending axis A in the first quadrant and from there can be pivoted as per the second quadrant into the work area. However, here problems do arise with the unfolding, which can result from the first boom arm being activated by a hydraulic cylinder, whose cylinder is connected to the boom arm and whose piston rod is connected to a control lever of the rotating head. This means that when the first boom arm is lifted, the hydraulic cylinder on the rod side is impinged on by compressed oil, so that to generate the force necessary for this, a correspondingly higher pressure may be needed due to the smaller piston surface embodied as an annular surface. Added to this is the fact that at the fixed point of the piston rod, in the area of the piston, strength problems can arise. Since the entire remainder of the boom set rests on the first boom arm, for reasons of strength, an unfolding strategy is needed to be able to lift the first boom arm. Additionally, for geometric reasons, it should be taken into consideration that the set of arms of an overhead roll-and-fold boom can project out beyond the operator's cab in the folded-up position. Thus, during lifting, first the set of arms should be released, so that there will be no collision with the operator's cab. For this reason it is advantageous for the set of arms to pivot about bending axis B, and particularly about a certain angle of 20°, for example. Then the first boom arm can be lifted about the A joint to a limit angle of about 65°, while the remainder of the set of arms is still folded up. In customary systems, a limit switch is found there, which in the operating state, ensures, for reasons of strength and stability, that the limit angle of 65° of the first boom arm is not fallen short of, independent of the setting of the remaining boom arms. For the same reason, when the remainder of the set of arms is pivoted out, care should be taken that boom arm 2 can also be oriented vertically, which corresponds to an angular setting of about 155° relative to arm 1. A limit switch is also found on boom arm 2, which ensures that boom arm 2 can stand vertically in the most extreme case. The vertical setting is switched, for example, via a tilt switch embodied as a mercury switch. In contrast, the upper boom arms are limited in their pivoting range only by structural limitations. Correspondingly, boom arm 3, with a pivoting range of 180°, will also be oriented vertically in cases in which arm 2 stands vertically.

Using the preset limit switch that in the operating state the A-joint cannot be deployed at the angle of 65° is perceived as a hindrance with certain concreting tasks. The same holds true for the B joint, since the vertical position does not always represent the ideal position for the concreting process.

These pre-sets have proven to be too rigid. They do not fully exhaust the possibilities of kinematics, but rather limit boom movement in a way that is clearly laid out, but not always practical.

### SUMMARY

Proceeding from this, an aspect of the present invention is to provide a structural principle whereby the rigid limits in operating a working boom are abolished, and more flexible manipulation and deployment options for the boom arms are ensured.

In an embodiment, the present invention provides a working boom with a head that is rotatable on a frame about a vertical axis. At least three boom arms are provided, each pivotable through a limited range about a respective horizontal bending axis relative to one of the rotating head or an adjoining mast arm, the horizontal bending axes being parallel to each other. A drive unit is associated with each boom arm and configured to pivot the respective boom arm, at least one of the drive units including a hydraulic cylinder having a ground and a rod-side end. A control device is operable to control boom movement using actuators associated with each drive unit and including an evaluation unit having a comparator. A plurality of first sensors for path or angular measurement are provided, each of the first sensors being associated with a respective one of the boom arms, bending axes, vertical axis or drive units. At least one second sensor including at least one of a pressure and a force sensor is provided disposed on at least one of the ground end or rod-side end of the hydraulic cylinder. A data storage device is configured to receive a pre-set data field, the pre-set data field including at least one of pressure and force limit values as a function of a respective path or measurement value associated with a respective one of the boom arms, the pre-set data field being analytical or in tabular form. The control device is configured to perform a safety routine in which the comparator receives output data of the at least one second sensor and either output data of a respective one of the first sensors or a quantity derived from output data of the respective one of the first sensors. The comparator is configured to perform a comparison with assigned limit value data from the data field and to trigger a signal if data from the sensors is outside of the limit value data.

### BRIEF DESCRIPTION OF THE DRAWINGS

The invention will be described in greater detail with respect to the following exemplary embodiment and the drawings, in which:

FIG. 1 shows a side view of a truck-mounted concrete pump with a working boom embodied in the form of an overhead roll-and-fold boom, in the folded-up state;

FIGS. 2a to 2d show a view of an unfolding strategy of an overhead roll-and-fold boom with the traditional safety device;

FIG. 3a shows a section of the boom arm 1 of an overhead roll-and-fold boom with dimensional specifications for determining the external instantaneous equilibrium (part system 1);

FIG. 3b shows a depiction as per FIG. 3a with dimensional specifications for determining the internal instantaneous equilibrium (part system 2);

FIG. 4 shows a section through the hydraulic cylinder of boom arm 1 with dimensional specifications for calculating the cylinder force;

FIG. 5 shows two diagrams regarding the limiting moment in joint A (upper curve) and the permitted cylinder forces (lower curve) in dependence on the pivoting angle of boom arm 1 about bending axis A;

FIG. 6a shows an overhead roll-and-fold boom in the operational state in a limit position according to traditional safety criteria;

FIGS. 6b and c show the overhead roll-and fold boom according to FIG. 6a in a permitted operational position according to the invention-specific safety criteria;

FIG. 7 shows a flow chart of the safety routine;

FIG. 8 shows a section of boom arm 1 of a standard concrete placing boom with a maximum bending angle about bending axis A of 90°;

FIG. 9 shows a side view of a placing boom of a truck-mounted concrete pump with a boom arm 1 able to be telescoped;

FIG. 10 shows a sectional side view of a working boom with a crane function; and

FIGS. 11a and b show a side view of a pumping device for wet or dry materials with a rotating head and a working boom that can be telescoped.

### DETAILED DESCRIPTION

An embodiment of the present invention is based on the idea that the safety device includes suitable sensor technology for the continuous determination of position and force measurement values within the working boom, as well as a safety routine that relates the determined measurement values to each other while maintaining the pre-set limit values for strength and/or stability of the system. Additionally, the design of the pump regarding maximum attainable pump pressure plays a role. Since the limit values for strength and stability are determined from the instantaneous boom configuration and thus from the instantaneous path and angle measurement values of the individual boom arms, the limit values necessary for safety monitoring can be pre-set while evaluating the kinematic relationships in analytical form or as tables. Accordingly, the an aspect of the invention is that the safety routine include a data storage device with a pre-set data field comprised of pressure or force limit values in dependence on at least the path or angle measurement values assigned to at least one of the boom arms, in analytical or tabular form, and that the evaluation unit have a comparator that receives output data from the pressure or force sensors and the associated path or angle sensors or quantities derived therefrom for carrying out a comparison with assigned limit value data from the data field and for triggering a signal when the limit value data are not reached or are exceeded.

According to an embodiment of the invention, the path sensor is assigned to the associated drive unit of the boom arm, which is embodied as a hydraulic cylinder. As an alternative to that, the angle sensor is disposed in the area of the bending axis of the associated boom arm.

In order to additionally incorporate stability into the oversight system, which is advantageous when a chassis frame carrying the bending boom is braced on one side in a constricted fashion, according to an embodiment of the invention it is proposed that an additional path or angle sensor be disposed on the drive unit or on the rotational axis of the rotating head, and that the data field containing pressure or force limit values stored in analytical or tabular form in the data storage device of the safety routine is additionally correlated with the path or angle measured values assigned to the rotating head.

Another embodiment of the invention makes provision that geodetic angle sensors for determining earth-fixed angle measurement values assigned to the individual boom arms are disposed on the boom arms. Additionally, a further geodetic angle sensor for measuring at least one earth-fixed angular measurement value assigned to the rotating head or the chassis frame can be provided on the rotating head and/or on the chassis frame. In this case, it is appropriate that the software routine has a coordinate transformer for recalculating earth-fixed, boom-arm-related angular measurement values into bending angles for the individual boom arms.

Another embodiment of the invention makes provision that at least one of the actuators responds to the signal that is issued via the safety routine when limit data are exceeded while performing a safety motion or a safety stop.

According to another embodiment of the invention, the control device has a position controller for boom movement that responds to the path or angle measurements.

Another embodiment of the invention makes provision that the control device comprises a vibration damper for the boom arms of the placing boom that responds to the time-dependent path or angle measurement values and/or to the pressure or force measurement values.

In the above, the invention was primarily explained using a concrete placing boom embodied as an overhead roll-and-fold boom. The invention is not limited to this embodiment version, but can also be used with working booms of other designs and applications. In what follows, some examples for this are presented:
A working boom in which the first boom arm can be pivoted relative to the rotating head by about 90° with the aid of the drive unit embodied as a hydraulic cylinder.
Along with the concrete placing boom embodied as a bending and/or telescopic boom, this also includes a telescopic pumping boom for mobile pumping devices.
Working booms, in which at the end of the first boom arm, a boom extender consisting of at least one additional boom arm is connected so as to pivot about a horizontal axis. A particular part of this is the concrete placing boom embodied as a bending boom.
Working booms in which the first boom arm is connected to multiple telescopic boom arms able to be moved longitudinally relative to each other. These include especially telescopic pumping devices for moist and dry materials.
Working booms in which at least one boom extender, which is composed of multiple boom arms that can be pivoted around horizontal axes relative to each other, is attached at the end of the boom arms that can be moved longitudinally that. These include especially bending booms in which one of the boom arms can be telescoped.
Working booms in which a guide roller is disposed on at least one boom arm, at an interval from the pivoting axis of the first boom arm, via which roller a cable with a device for receiving a mobile load is guided, wherein a pressure or force sensor is disposed on the cable, the output of which is linked to the evaluation unit of the safety routine. In such a case, the invention allows a safety monitoring of the working boom including the load suspended on the cable.

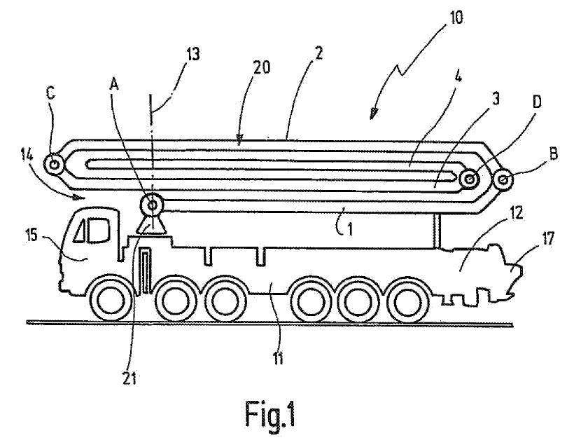

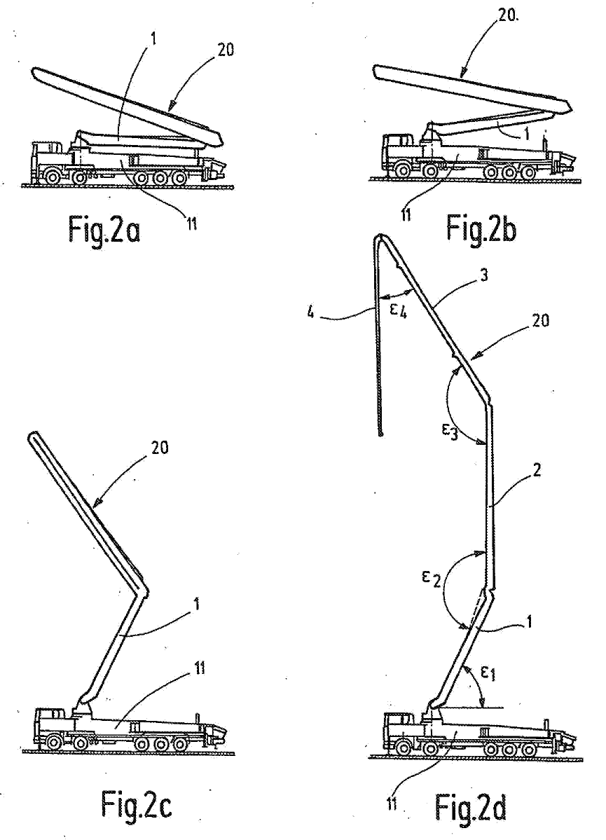

First an embodiment of the invention will be explained that includes a truck-mounted concrete pump with an overhead roll-and-fold boom, depicted in FIGS. 1, 2a to d and 6a to c.

The truck-mounted concrete pump 10 depicted in FIGS. 1, 2a to d and 6a to c, comprises a multiple-axle chassis frame 11 with a driver's cab 15, a thick-matter pump 12 as well as a working boom 14 that can be rotated about a vehicle-secured vertical axis 13 as a carrier for a concrete pumping line that is not shown. By way of the concrete pumping line, liquid concrete, which is continuously fed into a feeding container 17 during the concreting process, is pumped to a concreting location that is distant from the location of the vehicle 11.

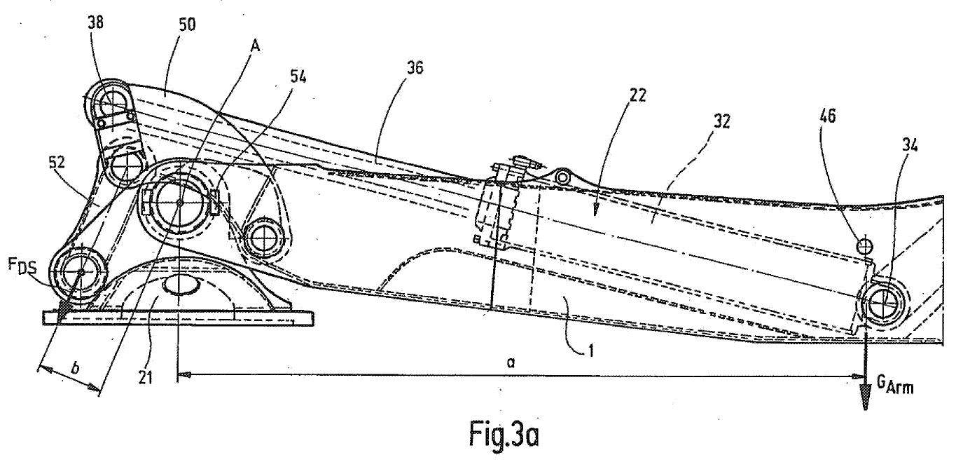

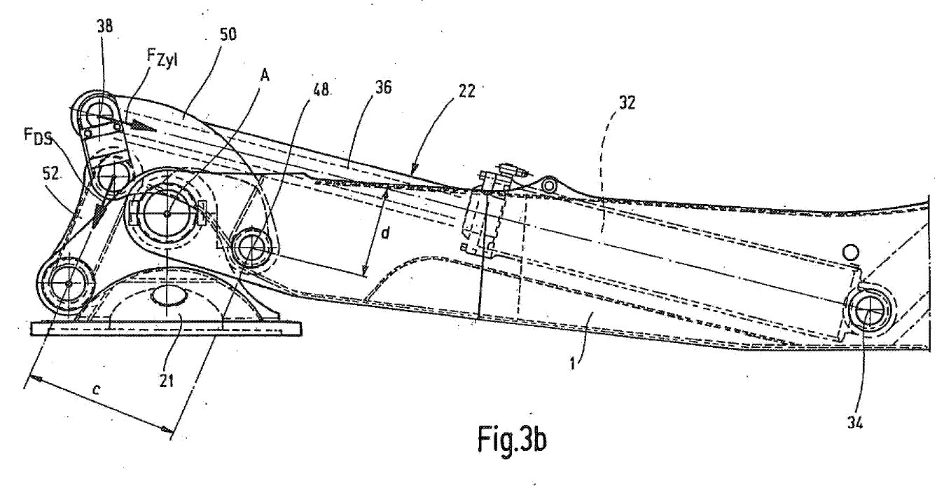

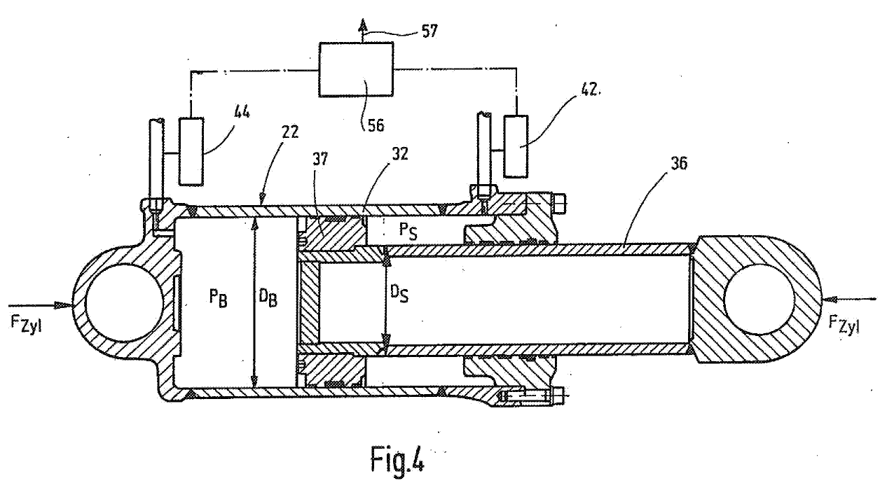

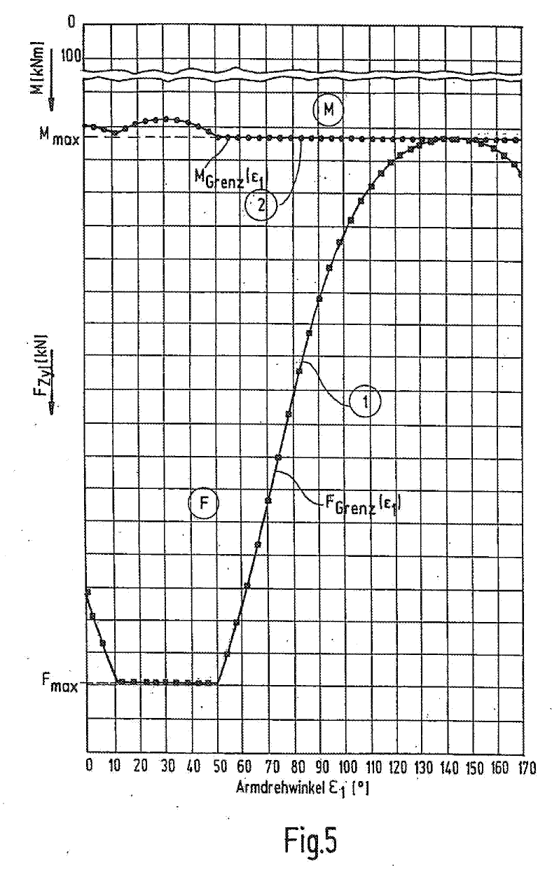

The working boom 14 consists of a rotating head 21 that can be rotated about the vertical axis 13 and a bending boom 20 that can be pivoted on it, which is continuously adjustable to a varied range and height difference between the chassis frame 11 and the concreting location. In the depicted embodiments, the bending boom consists of four boom arms 1 to 4 with joint connections to each other, which can be pivoted about bending axes A to D that are parallel to one another and running at right angles to vertical axis 13 of rotating head 21. The bending angles ε₁ to ε₄ (FIG. 2d) of the bending joints formed by bending axes A to D and their arrangement to each other are tuned to one another such that the working boom 14 with the space-saving transport configuration visible in FIG. 1, which corresponds to a multiple folding, is able to be placed on chassis frame 11. In the embodiments depicted in the drawings, the bending boom 20 forms an overhead roll-and-fold boom, in which boom arm 1, in its folded-together state, rests directly on chassis frame 11, and the other boom arms 2 to 4 are rolled up in worm fashion and in the rolled-up state project forward over the driver's cab 15. By activation of the drive units, which are configured in the embodiment examples shown in FIGS. 3 and 4 as well as 6a to c as double-acting hydraulic cylinders 22 to 25, which are individually assigned to bending axes A to D, the bending boom 20 is able to be unfolded from its folded-together transport setting into its unfolded operational setting (FIGS. 2a to d). The bending boom 20 can be unfolded only if the chassis frame 11 is braced by two front and two rear extension legs 26, 28 on the base onto the ground 30. At constricted construction sites, a lateral narrow support is possible with extension legs 26, 28, which requires additional safety measures when the bending boom 20 is folded out, to avoid the danger of tipping.

The bending booms 20 depicted in the various embodiments, embodied as overhead roll-and-fold booms, have the advantage that the set of booms unfolds relatively simply and speedily. In contrast to other types of folding, the set can be lifted about axis A and can be pivoted from the first quadrant into the operating area in the second quadrant. Since the entire remaining set of booms lies on boom arm 1, the unfolding strategy known per se and depicted in FIGS. 2a to d is necessary to be able to raise boom arm 1. This primarily derives from the remaining set of arms projecting out over the driver's cab 15. Therefore, first during raising, the set of arms as per FIGS. 2a and b is lifted about bending axis B by about ε₂=10° to 30° and then the arm 1 is lifted by a corresponding angle ε₁ so that with further pivoting there will be no collision in this area. To avoid overloading, then the arm 1 is lifted about bending axis 1 as per FIG. 2c to an angle ε₁=65° and simultaneously the arm 2 is lifted to an angle >90° before the additional boom arms as per FIGS. 2c and 2d can be folded out. With the traditional designs, in the operating condition, boom arm 1 is secured at an angle ε₁=65° by a limit switch, while boom arm 2 in the most extreme instance can be brought into its vertical position (FIG. 2d). The vertical position is secured by a tilt switch. In the embodiment shown, boom arm 3 has a possibility of being pivoted only to ε₃=180°. Therefore, in the case where arm 2 stands vertically, boom arm 3 will point vertically upward. It is primarily the traditional limits of the pivoting angles ε₁ and ε₂ drawn in FIG. 2d that are perceived to be hindrances in certain concreting tasks. On the other hand, they do not fully exploit the kinematic possibilities, but rather limit the pivoting angle at places that in fact are clear, but not always practical.

To be able to fully exploit the kinematic possibilities when the bending booms are operated, along with the layout of the hydraulic pump in regard to the maximum available pumping pressure, primarily the strength at the force-transmitting locations of the hydraulic cylinders and the stability of the system braced on the ground 30 can be taken into consideration. To maintain the limit criteria regarding strength and stability, suitable sensor technology is needed for monitoring the forces applied in the area of hydraulic cylinder 22 and the torque applied on the system by way of the unfolded bending boom 20.

The strength criterion relates above all to hydraulic cylinder 22 assigned to bending axis A, whose cylinder 32 is coupled in the area of axis 34 on boom arm 1, while the piston rod 36 in the area of axis 38 is coupled on a shifting lever 50 of rotating head 21. This means that cylinder 32 of boom arm 1 has compressed oil impinging on it on the rod side when lifted. Due to the small piston surface, a correspondingly higher pressure is required there to generate the cylinder force F_{cyl} required for lifting. On the other hand, due to the limit pressure of 380 bar, for example, that is available, the hydraulic system can make only a certain lifting force available. Added to this is that at the fixing point of piston rod 36 in the area of piston 37, strength problems can arise. These problems are taken into account once in the foldout procedure in the sense described above by an unfolding strategy according to FIGS. 2a to d. To be able to make full use of the limits also in the operating state, according to the invention, the pressure pₛ and p_{B} at the rod-side and ground-side end of hydraulic cylinder 22 is monitored by means of pressure sensors 42, 44, and evaluated in an evaluation circuit for determining the instantaneous cylinder force:

$${F}_{cyl} = {F}_{B} - {F}_{S} = \frac{π}{4} {D}_{B}^{2} {p}_{B} - \frac{π}{4} ( {D}_{B}^{2} - {D}_{S}^{2} ) \cdot {p}_{S} \qquad ( 1 )$$

wherein F_{B} and F_{S} are the forces on the ground side and rod side, p_{B} and pₛ are pressures on the ground side and the rod side, D_{B} is the cylinder diameter and Dₛ is the piston rod diameter.

For reasons of strength, the cylinder force F_{cyl} may not exceed a maximum value Fₘₐₓ which takes into account that the welded seams in the area of the piston and the bending forces in the piston and in the cylinder are subject to a maximum loading. By comparing the cylinder force F_{cyl} measured and computed according to formula (1) with pre-set limit values, by means of an evaluation circuit 56, monitoring can be done of overshoots of the limit value and a corresponding signal 57 can be triggered. For example, with signal 57, operation of the bending boom can be interrupted.

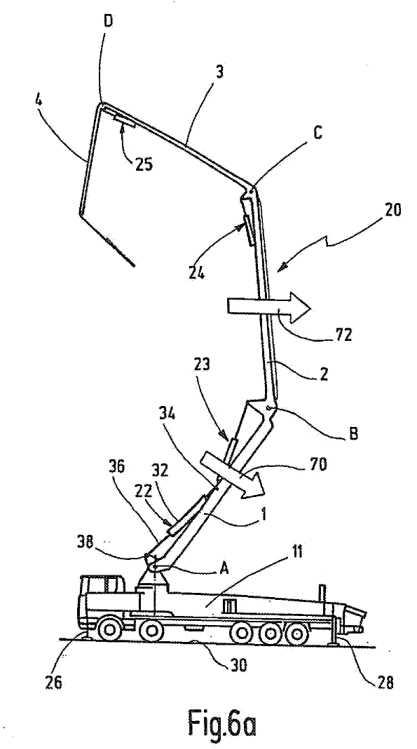

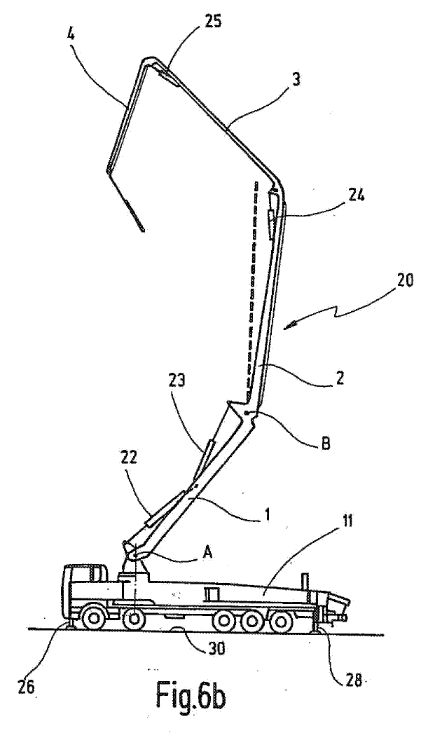

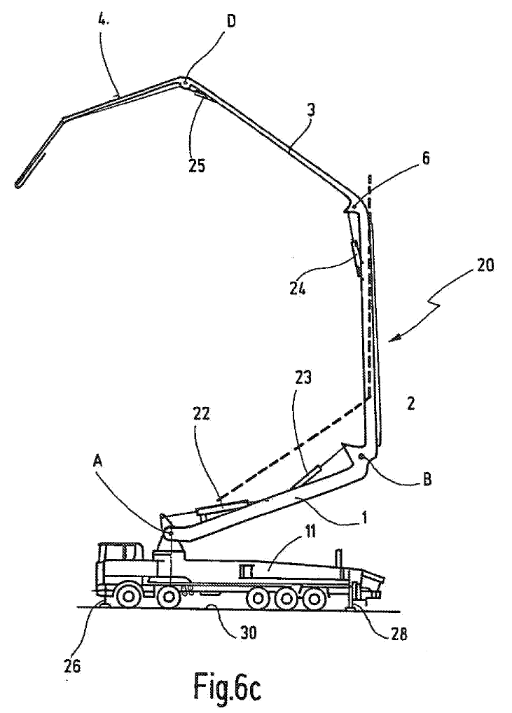

Another limit is represented by the torques M applied by way of the bending boom on the overall system that can have an effect on stability. In the overhead roll-and-fold booms, this is primarily the operating modes in the gantry position of boom arm 1, in which the safety angle ε₁ of 65° is fallen short of (arrow 70 in FIG. 6a) and/or in which boom arm 2 is pivoted from its vertical position into the gantry position (arrow 72 in FIG. 6a). This problem primarily arises when there is constricted, one-side support, in which the bending boom 20 is brought by way of the vertical axis 13 into a lateral working position relative to the longitudinal axis of the truck.

The kinematic elements necessary for determining the instantaneous equilibrium are shown in FIG. 3a for an external part system 1 with the elements: rotating head 21, arm & set of arms 1 and push rod 52 for an inner part system 2 with the elements: shift lever 50, push rod 52 and hydraulic cylinder 22.

In part system 1 the external instantaneous equilibrium about bending axis A of boom arm 1 is calculated as follows:

ΕM (axis A)=0 (2)

−F_{DS}·b+Gₐᵣₘ·a=0

Here F_{DS} means the force applied on the push rod 52, while Gₐᵣₘ means the equilibrium force of the set of arms, which is applied at focal point 46. The distances a and b define the distances from bending axis A that define the torque.

From formula (2) is derived the relation

$${F}_{DS} = \frac{{G}_{arm} \cdot a}{b} \qquad ( 3 )$$

The inner instantaneous equilibrium for part system 2 consisting of shifting lever 50, push rod 52 and hydraulic cylinder 22 is derived from FIG. 3b, related to the rotational axis 48 of shifting lever 50 as follows:

ΕM (axis 48)=0 (4)

−F_{DS}·c+F_{cyl}·d=0

wherein F_{DS} is the force applied to the push rod and F_{cyl} is the cylinder force, as well as c and d being the associated distances from rotational axis 48.

From formulas (4) and (3) for the two part systems 1 and 2, a relation can be derived for the cylinder force F_{cyl} in dependence on the equilibrium force Gₐᵣₘ of the set of arms and the distances a to d:

$${F}_{cyl} = \frac{{G}_{arm} \cdot a \cdot c}{d \cdot b} \qquad ( 5 )$$

If the dependence of the distance variables a to d on the bending angle ε₁ of boom arm 1 is allowed for, and if additionally the maximum cylinder force Fₘₐₓ allowed for strength reasons is allowed for, then a limit curve is obtained for the cylinder force Fₗᵢₘ (ε₁) in kN corresponding to the curve 1 of the diagram as per FIG. 5 in dependence on the arm turning angle (bending angle) ε₁. Curve 2 shows a limit curve for the permissible loading moment Mₗᵢₘ (ε₁) in kNm. The permissible cylinder force range is designated in the diagram by F and the permissible loading moment range by M. To be allowed for in this is that the arm turning angle ε₁=0° corresponds to the horizontal boom arm 1, and the arm turning angle ε₁=90° to the vertical boom arm 1.

In the lower arm turning angle range of 0° to 10°, there results a limit range Fₗᵢₘ that is limited relative to the maximum force Fₘₐₓ, which results from reaching a limit for the shift lever force. The plateau between 10° and 50° is determined by the theoretical maximum permissible cylinder force Fₘₐₓ. Correspondingly, in the plateau there also results a permissible loading moment range Mₗᵢₘ that is limited relative to Mₘₐₓ. At arm turning angles ε₁ above 50° the cylinder force Mₗᵢₘ is limited by the theoretical permissible loading moment Mₘₐₓ.

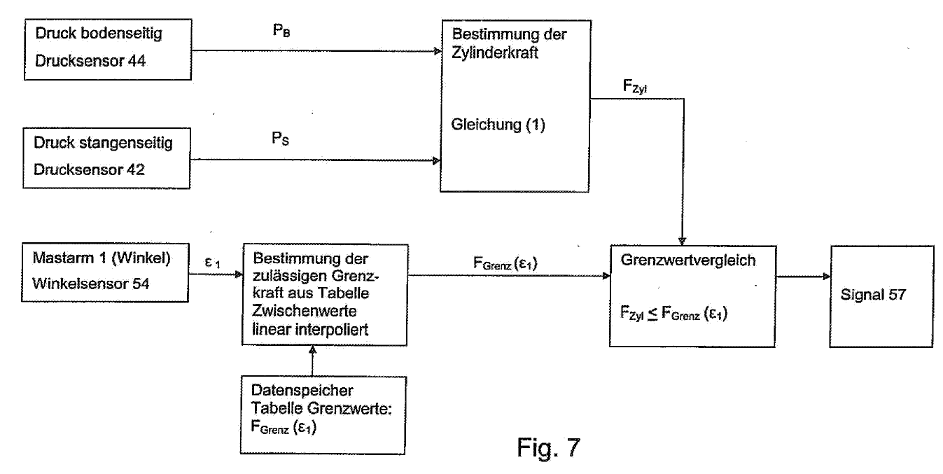

The curve 1 was pre-set in tabular form as a data field for the limit value of the cylinder force Fₗᵢₘ and compared using a software routine (FIG. 7) with the measurement values F_{cyl} that are derived with the aid of pressure sensors 42, 44 while allowing for formula (1), and in fact in dependence on the particular angle measurement value ε₁, which is determined with the aid of an angle or path sensor assigned to bending axis A. While doing so, the angular measurement value can be determined by an angle sensor 54 placed at bending axis A. Also for this fundamentally a path sensor linked with the piston rod 36 and the cylinder 32 of hydraulic cylinder 22 can be used, with appropriate conversion of the path data into angular data. A third possibility consists in the use of a geodetic angle sensor that is linked with boom arm 1, and whose measurement value can be converted into an angle measurement value about bending axis A.

The invention-specific safety device thus makes it possible, from the sensory measurement values P_{S}, P_{B}, ε₁ and the cylinder force F_{cyl} that is derived from this by comparison with the limit values Fₗᵢₘ (ε₁) according to FIG. 5

F_{cyl}≦Fₗᵢₘ(ε₁) (6)

to compute permitted arm configurations that exploit the kinematic possibilities better than previously. The limit value monitoring explained above is illustrated using FIG. 7 in a flow diagram of a safety routine. A further improvement in this regard is achieved in that appropriate limit value tables for additional boom arms, especially boom arm 2, and corresponding sensors in the area of these boom arms, are also incorporated into the safety device.

As a further variable, the rotational position of bending boom 20 about the vertical axis 13 can be added, which primarily in the limit range of constricted one-side support, results in better utilization of the working range of the bending boom.

In FIGS. 6a to c, broadenings achieved in the pivoting range of boom arms 1 and 2 in the direction of arrows 70, 72 (FIG. 6a) are indicated as simple examples, which, when the limit value monitoring explained above is allowed for, can be attained relative to the customary limit angles indicated in dashed lines in FIGS. 6b and c.

The sensors provided for measurement of the invention-specific pressure and angular values also find their application in computer-controlled activation of the multiple-armed bending boom 20 with the aid only of a remote-controlled control lever (also see DE 101 07 107 A) and in the vibration damping of bending booms (also see DE 100 46 546 A1). Thus the sensor technology installed in the system obtains multiple usage in the various areas of system controls and monitoring.

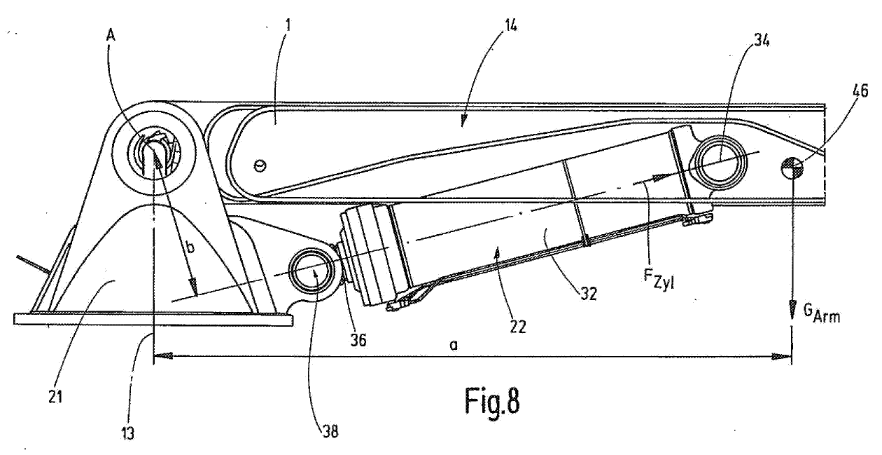

Above, the invention was exhaustively explained using an overhead roll-and-fold boom as a first embodiment example. The concepts underlying the invention can also be transferred to a multiplicity of further application cases. In what follows this will be explained by the application cases depicted in FIGS. 8 to 11.

FIG. 8 depicts a section of a standard concrete distributor boom, whose rotating angle ε₁ about the bending axis A of boom arm 1 is 90°. The kinematic elements necessary for determining instantaneous equilibrium are depicted in FIG. 8 in dependence on FIG. 3a and on the reference symbols provided there. For the instantaneous equilibrium according to that, the following relation is obtained:

$${G}_{arm} \cdot a = {F}_{cyl} \cdot b \\ {F}_{cyl} = \frac{{G}_{arm} \cdot a}{b} \qquad ( 7 )$$

If we take into account that the distance variables a and b are dependent on the bending angle ε₁ of boom arm 1, and if we further take into account the maximum cylinder force Fₘₐₓ that is permissible for strength reasons, then, similar to the case of the embodiment example exhaustively explained above for the overhead roll-and-fold boom, we obtain a limit curve for the cylinder force Fₗᵢₘ (ε₁) in dependence on the arm rotating angle (bending angle) ε₁. Further, a limit curve can be indicated for the permissible loading moment Mₗᵢₘ (ε₁). With these curves stability can be monitored with boom movement as per the presentations above.

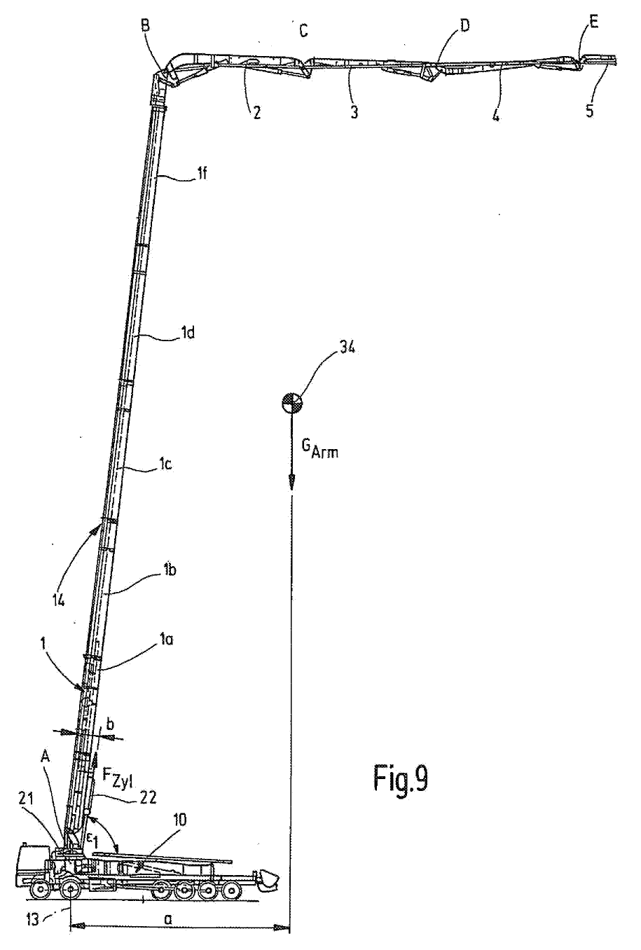

The embodiment shown in FIG. 9 is a truck-mounted concrete pump 10 with a concrete distributor boom, whose boom arm 1 is able to be pivoted about a pivoting angle ε₁ about bending angle A of rotating head 21. Boom arm 1 consists of multiple boom segments 1a to 1f that can be telescoped into each other, on whose end is attached a bending boom extender with multiple further boom arms 2, 3, 4, 5.

The instantaneous equilibrium about bending axis A of boom arm 1 that is relevant for the stability monitoring here also leads to formula (7).

If the dependence of the distance variables a and b from the bending angle ε₁ of boom 1 and from the position of the remaining boom arms is taken into account, and if additionally the maximum cylinder force Fₘₐₓ permissible for strength reasons is taken into account, then in turn we obtain a limit curve similar to FIG. 5 for the cylinder force F_{cyl} in dependence on the arm rotating angle ε₁.

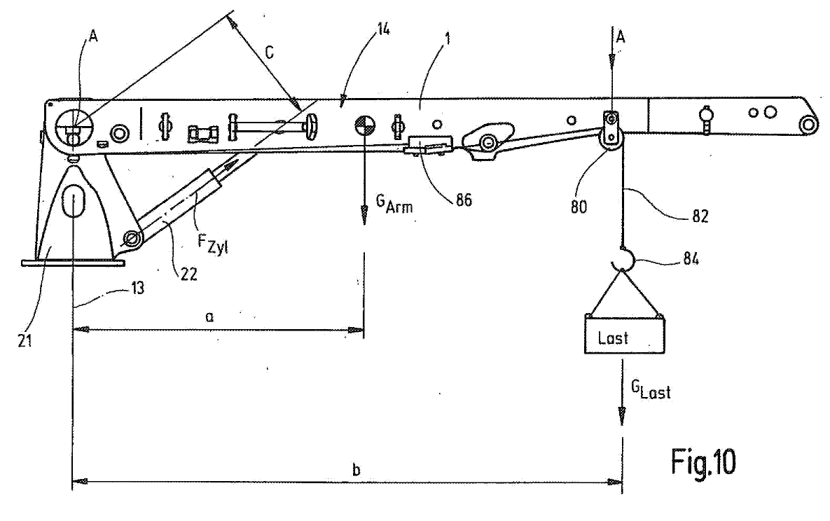

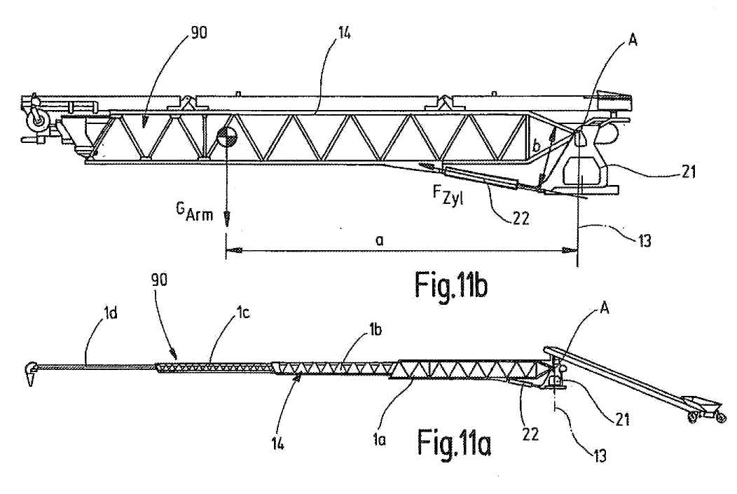

In the embodiment shown in FIG. 10, a working boom 14, for example of a concrete pump, is sectionally depicted, which also functions as a crane for lifting a load. For this purpose there is disposed at a distance b from the bending axis A of boom arm 1 a guide roller 80, via which a cable 82 with a take-up device 84 for a moving load is guided. Additionally, a force sensor 86 is disposed on cable 82 for determining the force of weight G_{load}, whose output is connected to the evaluation component of a safety routine. By means of this system, the instantaneous equilibrium about the bending axis A of boom arm 1 is calculated as follows:

$${F}_{cyl} \cdot c = {G}_{arm} \cdot a + {G}_{load} \cdot b \\ {F}_{cyl} = \frac{{G}_{arm} \cdot a + {G}_{load} \cdot b}{c} \qquad ( 8 )$$

If we make allowance for the dependence of the distance variables a, b and c on the angle ε₁ of boom arm 1 and on the position of the other boom arms, and if in addition we make allowance for the maximum cylinder force Fₘₐₓ permissible for strength reasons, here also we obtain a limit curve for the cylinder force Fₗᵢₘ (ε₁) that permits oversight of stability.

In the embodiment example shown in FIGS. 11a and b is a mobile conveyor belt 90 with a working boom 14 attached to a rotating head 21 with boom arms 1a to 1d that can be telescoped into each other. The working boom 14 can be pivoted about the bending axis A at an angle ε₁ with the aid of a drive unit that is embodied as a hydraulic cylinder 22.

For determination of the instantaneous equilibrium, the dimensions and forces indicated in FIG. 11b are to be allowed for. Here an equilibrium condition is computed in correspondence to equation (7). If in turn allowance is made for the dependence of the distance variables a and b on bending angle ε₁ of boom 14 and on the position of boom arms 1a to 1d, and if in addition allowance is made for the maximum cylinder force Fₘₐₓ permissible for strength reasons, then in turn a limit curve for the cylinder force Fₗᵢₘ (ε₁) corresponding to curve 1 of FIG. 5 is obtained. This curve is pre-set in tabular form as a data field for the limit value of cylinder force and compared by a software routine as per FIG. 7 with the measured values F_{cyl}.

Thus for all the embodiments, a permissible arm configuration of the working boom 14 can be determined, which corresponds to the safety criterion as per equation (6).

In summary, the following is determined: In an embodiment, the invention relates to a working boom, especially for large manipulators and concrete pumps. The working boom 14 has a rotating head 21 that can rotate about a vertical axis 13 on a chassis frame 11, a first boom arm 1 that can do limited pivoting about a horizontal bending axis A relative to the rotating head 21 by means of a drive unit 22, and at least one additional boom arm 2, 3, 4 that is able to be longitudinally moved relative to an adjoining boom arm by means of an associated drive unit 23 to 25 and/or be pivoted about a horizontal bending axis B, C, D. Further, a preferably remotely controllable control device is provided for boom movement with the aid of the actuators assigned to the individual drive units. Primarily control valves are considered as the actuators, by which the drive units 22 to 25 embodied as hydraulic cylinders are controlled. On at least one of the boom arms, the thrust and/or bending axes, the vertical axis 13 and/or the drive units 22 to 25, a sensor 54 is disposed for path or angular measurement. The control device has a safety routine that responds to the output data of the sensors. Additionally, on the ground-side and rod-side end of at least one of the drive units embodied as a hydraulic cylinder 22, pressure or force sensors 42, 44 are disposed, while the safety routine comprises an evaluation component 56 that responds to the output data of the pressure or force sensors. To be able to better exploit the kinematics during motion of the bending booms, the safety routine comprises a data storage device for receiving a data field pre-set analytically or in table form from pressure or force limit values in dependence on at least one of the path or angular measurement values assigned to the boom arms. The evaluation unit 56 has a comparator that receives output data from the pressure or force sensors 42, 44 or the associated path or angular sensors 54, or measurements derived therefrom, for carrying out a comparison with assigned limit value data from the data field, and for triggering a signal when the limit value data are exceeded or fallen short of.

1-18. (canceled)

19. A working boom comprising:
a rotating head rotatable on a frame about a vertical axis;
at least three boom arms, each pivotable through a limited range about a respective horizontal bending axis relative to one of the rotating head or an adjoining mast arm, the horizontal bending axes being parallel to each other;
a drive unit associated with each boom arm and configured to pivot the respective boom arm, at least one of the drive units including a hydraulic cylinder having a ground and a rod-side end;
a control device operable to control boom movement using actuators associated with each drive unit and including an evaluation unit having a comparator;
a plurality of first sensors for path or angular measurement, each of the first sensors being associated with a respective one of the boom arms, bending axes, vertical axis or drive units;
at least one second sensor including at least one of a pressure and a force sensor and disposed on at least one of the ground end or rod-side end of the hydraulic cylinder; and
a data storage device configured to receive a pre-set data field, the pre-set data field including at least one of pressure and force limit values as a function of a respective path or measurement value associated with a respective one of the boom arms, the pre-set data field being analytical or in tabular form;
wherein the control device is configured to perform a safety routine in which the comparator receives output data of the at least one second sensor and either output data of a respective one of the first sensors or a quantity derived from output data of the respective one of the first sensors, and wherein the comparator is configured to perform a comparison with assigned limit value data from the data field and to trigger a signal if data from the sensors is outside of the limit value data.

20. The working boom as recited in claim 19 wherein the control device is a remote-control device.

21. The working boom as recited in claim 19 further comprising:
a guide roller disposed on at least one boom arm at a distance from the bending axis of a first of the boom arms, the guide roller configured to guide a cable with a suspending device for a mobile load; and
a third sensor including at least one of a force or pressure sensor disposed on the cable, an output of the third sensor being connected with the evaluation unit for the safety routine.

22. The working boom as recited in claim 19 wherein at least one angular sensor of the first sensors is disposed on a corresponding boom arm.

23. The working boom as recited in claim 19 wherein at least one path sensor of the first sensors is disposed on the hydraulic cylinder.

24. The working boom as recited in claim 19 wherein one of the first sensors is disposed on one of the rotating head or a drive unit corresponding to the rotating head, and wherein the data field is correlated with path or angular measurement values assigned to the rotating head.

25. The working boom as recited in claim 19 wherein at least one of the actuators responds to the triggered signal while carrying out a safety movement or a safety stop.

26. The working boom as recited in claim 19 wherein the control device comprises a position controller configured to control boom movement responding to path or angular measurement data.

27. The working boom as recited in claim 19 wherein at least one of the first sensors includes a geodetic angle sensor configured to make path or angular measurements of the boom arm.

28. The working boom as recited in claim 27 wherein at least one of the first sensors includes a second geodetic angular sensor disposed on the rotating head and configured to measure earth-fixed angular measurement values assigned to the rotating head.

29. The working boom as recited in claim 27 wherein at least one of the first sensors includes an angle sensor disposed on the frame and configured to measure at least one earth-fixed angular measurement value assigned to the frame.

30. The working boom as recited in claim 27 wherein the geodetic sensor includes an inclination angle sensor responding to gravity.

31. The working boom as recited in claim 27 wherein the control device is configured to convert earth-fixed angular measurement values of the boom arm into bending angles.

32. The working boom as recited in claim 19 wherein the control device comprises a vibration damper for the boom arms of a distributor boom responding to at least one of time-dependent values of path or angular measurement and pressure or force measurement values.

33. A working boom comprising:
a rotating head rotatable on a frame about a vertical axis;
a first boom arm pivotable through a limited range about a horizontal bending axis relative to the rotating head;
at least one additional boom arm longitudinally slidable along at least one of a thrust axis or horizontal bending axis relative to an adjoining boom arm;
a drive unit associated with the first boom arm and configured to pivot the first boom arm, and a drive unit corresponding to the additional boom arm and configured to slide the additional boom arm, at least one of the drive units including a hydraulic cylinder having a ground and a rod-side end;
a control device operable to control boom movement using actuators associated with each drive unit and including an evaluation unit having a comparator;
a plurality of first sensors for path or angular measurement, each of the first sensors being assigned with a respective one of the boom arms, bending axes, vertical axis or drive units;
at least one second sensor including at least one of a pressure and a force sensor and disposed on at least one of the ground end or rod-side end of the hydraulic cylinder; and
a data storage device configured to receive a pre-set data field, the pre-set data field including at least one of pressure and force limit values as a function of a respective path or measurement value associated with a respective one of the boom arms, the pre-set data field being analytical or in tabular form;
wherein the control device is configured to perform a safety routine in which the comparator receives output data of the at least one second sensor and either output data of a respective one of the first sensors or a quantity derived from output data of the respective one of the first sensors, and wherein the comparator is configured to perform a comparison with assigned limit value data from the data field and to trigger a signal if data from the sensors is outside of the limit value data.

34. The working boom as recited in claim 33 wherein the control device is a remote-control device.

35. The working boom as recited in claim 33 wherein the hydraulic cylinder is associated with the first boom arm and is configured to pivot the first boom arm by about 90° relative to the rotating head.

36. The working boom as recited in claim 33 wherein a boom extension is attached to an end of the first boom arm, the boom extension comprising at least one additional boom arm and being pivotable about a horizontal bending axis.

37. The working boom as recited in claim 33 further comprising a plurality of additional boom arms which are longitudinally slidable in a telescopic fashion into one another, the plurality of additional boom arms being coupled to the first boom arm.

38. The working boom as recited in claim 37 further comprising at least one boom extension comprising a plurality of further boom arms pivotable relative to one another about horizontal bending axes, the at least one boom extension being coupled to a last boom arm of the additional boom arms.

39. The working boom as recited in claim 33 further comprising:
a guide roller disposed on at least one boom arm at a distance from the bending axis of a first of the boom arms, the guide roller configured to guide a cable with a suspending device for a mobile load; and
a third sensor including at least one of a force or pressure sensor disposed on the cable, an output of the third sensor being connected with the evaluation unit for the safety routine.

40. The working boom as recited in claim 33 wherein at least one angular sensor of the first sensors is disposed on a corresponding boom arm.

41. The working boom as recited in claim 33 wherein at least one path sensor of the first sensors is disposed on the hydraulic cylinder.

42. The working boom as recited in claim 33 wherein one of the first sensors is disposed on one of the rotating head or a drive unit corresponding to the rotating head, and wherein the data field is correlated with path or angular measurement values assigned to the rotating head.

43. The working boom as recited in claim 33 wherein at least one of the actuators responds to the triggered signal while carrying out a safety movement or a safety stop.

44. The working boom as recited in claim 33 wherein the control device comprises a position controller configured to control boom movement responding to path or angular measurement data.

45. The working boom as recited in claim 33 wherein at least one of the first sensors includes a geodetic angle sensor configured to make path or angular measurements of the boom arm.

46. The working boom as recited in claim 45 wherein at least one of the first sensors includes a second geodetic angular sensor disposed on the rotating head and configured to measure earth-fixed angular measurement values assigned to the rotating head.

47. The working boom as recited in claim 45 wherein at least one of the first sensors includes an angle sensor disposed on the frame and configured to measure at least one earth-fixed angular measurement value assigned to the frame.

48. The working boom as recited in claim 45 wherein the geodetic sensor comprises an inclination angle sensor responding to gravity.

49. The working boom as recited in claim 45 wherein the control device is configured to convert earth-fixed angular measurement values of the boom arm into bending angles.

50. The working boom as recited in claim 33 wherein the control device comprises a vibration damper for the boom arms of a distributor boom responding to at least one of time-dependent values of path or angular measurement and pressure or force measurement values.
